(19) United States
(12) Patent Application Publication
(10) Pub. No.: US 2026/0040249 A1
(43) Pub. Date: Feb. 5, 2026

(54) MULTI-STATE GROUND AND SPACE COMMUNICATION SYSTEM AND METHOD THEREOF AND COMMUNICATION PLATFORM SERVER

(71) Applicant: Charles Lap San CHAN, Taipei (TW)

(72) Inventor: Charles Lap San CHAN, Taipei (TW)

(21) Appl. No.: 19/289,508

(22) Filed: Aug. 4, 2025

(30) Foreign Application Priority Data
Aug. 5, 2024 (TW) 113129242

(51) Int. Cl. H04W 56/00; H04L 5/00; H04W 72/0453

(52) U.S. Cl. CPC H04W 56/0035; H04L 5/0048; H04W 72/0453

(57) ABSTRACT

A multi-state ground and space communication system and method thereof and a communication platform server are provided. The system includes a plurality of communication devices, fixed base stations, mobile communication vehicles, and satellites, wherein each fixed base station, mobile communication vehicle, and satellite is equipped with a communication platform server. The system determines whether the current state is a first state period or a second state period based on externally transmitted status signals, and selects communication modes accordingly. During the first state period, communication devices communicate through the communication platform server of the fixed base station; during the second state period, communication devices communicate through the communication platform server of the mobile communication vehicle or satellite.

### BACKGROUND OF THE INVENTION

This application claims priority for the TW patent application no. 113129242 filed on 5 Aug. 2024, the content of which is incorporated by reference in its entirely.

### FIELD OF THE INVENTION

The present invention relates to a ground and space communication system and method thereof and a communication platform server, and more particularly to a multi-state ground and space communication system and method thereof that can provide different communication networks according to different scenarios to maintain uninterrupted communication.

### DESCRIPTION OF THE RELATED ART

Existing communication systems primarily rely on fixed terrestrial infrastructure, such as cellular network base stations, which can provide reliable communication services under normal circumstances. However, these systems often prove vulnerable when facing natural disasters, large-scale emergencies, or other special environments. Some research and inventions have been dedicated to solving this problem, proposing solutions that use mobile base stations or rapidly deployable communication equipment to provide temporary communication services in emergency situations. However, these solutions typically lack integration with satellite networks, limiting their scope of application in large-scale disaster situations. On the other hand, pure satellite communication systems, while capable of providing extensive geographical coverage, may face issues such as high costs and large communication delays in daily use.

Existing technologies generally lack a comprehensive solution that can provide reliable communication services in both normal and emergency situations while having an intelligent data synchronization mechanism. Many systems lack the ability to seamlessly switch between different communication modes and do not consider the need to optimize data synchronization under different circumstances.

### SUMMARY OF THE INVENTION

An object of the disclosure is to provide a ground and space communication system and method thereof, particularly a multi-state ground and space communication system and method thereof that can provide different communication networks according to different scenarios to maintain uninterrupted communication.

Another object of the disclosure is to provide a ground and space communication system and method thereof that can consider the need to optimize data synchronization under different circumstances.

To achieve the above objects, the disclosure provides a multi-state ground and space communication system comprising:
a plurality of communication devices;
at least one fixed base station having a first communication platform server built therein;
at least one mobile communication vehicle having a second communication platform server built therein;
at least one satellite having a third communication platform server built therein;
wherein the first, second, or third communication platform server receives a status signal transmitted from an external device to determine whether the current communication state is a first state period or a second state period;
during the first state period, the plurality of communication devices are configured to interconnect and communicate through the first communication platform server of the fixed base station; and
during the second state period, the plurality of communication devices are configured to selectively interconnect and communicate through the second communication platform server of the mobile communication vehicle or the third communication platform server of the satellite.

The disclosure also provides a multi-state ground and space communication method comprising the steps of:
providing a plurality of communication devices, at least one fixed base station, at least one mobile communication vehicle, and at least one satellite, wherein the fixed base station has a first communication platform server built therein, the mobile communication vehicle has a second communication platform server built therein, and the satellite has a third communication platform server built therein;
receiving a status signal transmitted from an external device, the status signal being used to determine whether the current communication state is a first state period or a second state period;
during the first state period, causing the plurality of communication devices to interconnect and communicate through the first communication platform server of the fixed base station; and
during the second state period, causing the plurality of communication devices to selectively interconnect and communicate through the second communication platform server of the mobile communication vehicle or the third communication platform server of the satellite.

The features, advantages, or similar expressions mentioned in the specification do not mean that all the features and advantages that can be realized by the disclosure should be in any single specific embodiment of the disclosure. Rather, it should be understood that the expression of related features and advantages means that the specific features, advantages, or characteristics described in conjunction with specific embodiments are included in at least one specific embodiment of the disclosure. Therefore, the discussion of features and advantages, and similar expressions in the specification is related to the same specific embodiment, but it is not necessary.

Below, the embodiments are described in detail in cooperation with the drawings to make easily understood the technical contents, characteristics and accomplishments of the disclosure.

### BRIEF DESCRIPTION OF THE DRAWINGS

FIG. 1 shows a multi-state ground and space communication system according to a preferred embodiment of the disclosure.

FIG. 2 shows a flowchart of a multi-state ground and space communication method according to a preferred embodiment of the disclosure.

FIG. 3 shows a flowchart of a communication method of a communication platform server according to a preferred embodiment of the disclosure.

FIG. 4 shows a block diagram of a communication platform server suitable for implementing embodiments of the disclosure.

### DETAILED DESCRIPTION OF THE INVENTION

To make the description of the present disclosure more detailed and complete, the following provides illustrative descriptions of embodiments and specific implementations of the present case; however, this is not the only form of implementing or applying specific embodiments of the disclosure. The embodiments cover features of multiple specific embodiments and method steps and their sequences for constructing and operating these specific embodiments. However, other specific embodiments may also be used to achieve the same or equivalent functions and step sequences.

It should be noted that unless otherwise specified, all functions described herein can be performed in hardware or as software instructions capable of causing a computer to perform predetermined operations, wherein the software instructions are implemented in computer-readable storage media, such as RAM, hard disk drives, flash memory, or other types of computer-readable storage media known to those skilled in the art. In some embodiments, the predetermined operations of the computer a reperformed by a processor, such as a computer, or according to program codes such as computer program codes, software, firmware, and in some embodiments, by integrated circuits encoded to perform these functions. Furthermore, it should be understood that various operations described herein as being performed by a user can be performed manually by the user or can be performed automatically with or without instructions provided by the user.

To make the objects, technical solutions, and advantages of the embodiments of the disclosure clearer, the technical solutions in the embodiments of the disclosure will be clearly and completely described below in conjunction with the drawings in the embodiments of the disclosure. Obviously, the described embodiments are part of the embodiments of the disclosure, not all embodiments. Based on the embodiments of the disclosure, all other embodiments obtained by those of ordinary skill in the art without making creative efforts fall within the scope of protection of the disclosure.

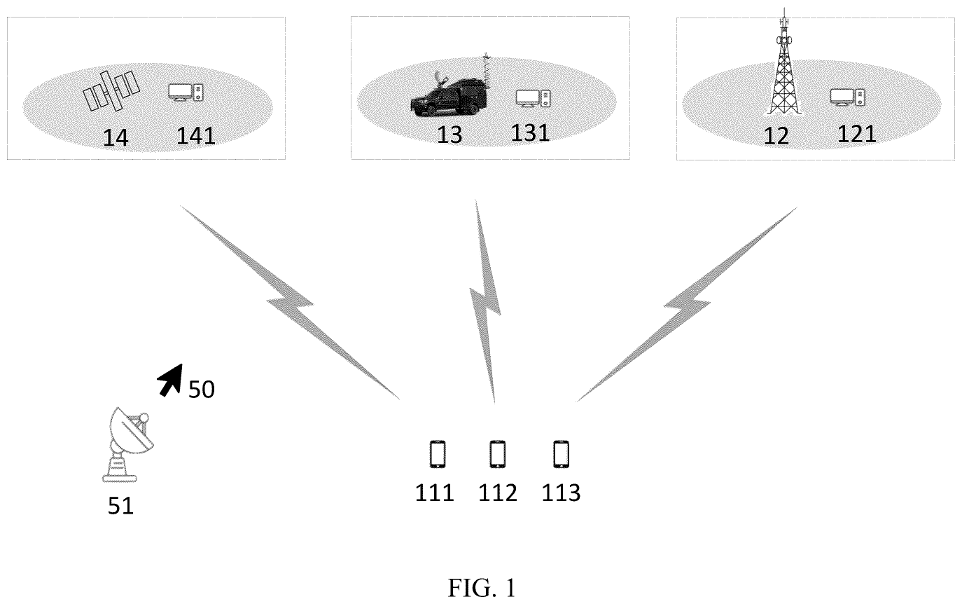

FIG. 1 shows a multi-state ground and space communication system according to a preferred embodiment of the disclosure. As shown in FIG. 1, it includes: a plurality of communication devices 111, 112, 113, at least one fixed base station 12, at least one mobile communication vehicle 13, and at least one satellite 14. The fixed base station 12 has a first communication platform server 121 built therein, the mobile communication vehicle 13 has a second communication platform server 131 built therein, and the satellite 14 has a third communication platform server 141 built therein. It should be understood that the communication system of the disclosure may also include more fixed base stations, more mobile communication vehicles, and more satellites, and each fixed base station, mobile communication vehicle, or satellite has a communication platform server built therein. For ease of explanation, only one fixed base station 12, one mobile communication vehicle 13, and one satellite 14 are used as examples.

The communication devices 111, 112, 113 can be various forms of terminal equipment, including but not limited to smartphones, tablet computers, laptop computers, desktop computers, wearable devices (such as smartwatches), Internet of Things devices, vehicle communication systems, and professional military or emergency communication equipment such as satellite phones, tactical radios, etc. These communication devices 111, 112, 113 are all equipped with appropriate hardware, such as processors, memory, communication modules (including cellular network modules, Wi-Fi modules, Bluetooth modules, satellite communication modules, etc.), and user interfaces (such as touchscreens, keyboards, microphones, speakers, etc.).

The fixed base station 12 is typically a fixed-location communication facility, which may include traditional cellular network base stations, 5G base stations, wireless network access points, etc. The hardware equipment of the fixed base station 12 may include high-power transmitters, receivers, signal processing units, network switching equipment, power systems (including backup power), cooling systems, etc. The fixed base station 12 has a first communication platform server 121 built therein, which may be a high-performance computer system that may include multiple server racks, storage arrays, load balancers, etc.

The mobile communication vehicle 13 is a movable communication facility typically designed to operate in various terrains and environments. It may be a modified large truck or specially designed vehicle equipped with deployable antenna systems, satellite communication equipment, multiple wireless communication systems (such as LTE, 5G, short wave, ultra-short wave, etc.), generators, air conditioning systems, etc. The mobile communication vehicle 13 has a second communication platform server 131 built therein, which may be a small but high-performance computer system with powerful processing capabilities and storage capacity.

The satellite 14 may be a geostationary orbit satellite, medium orbit satellite, or low orbit satellite, equipped with multi-band communication systems, solar panels, attitude control systems, thermal control systems, etc. The satellite 14 has a third communication platform server 141 built therein, which may be a computer system specially designed for space environments with high reliability and radiation resistance.

In the communication system of the disclosure, at least one of the first, second, or third communication platform servers 121, 131, 141 can receive a status signal 50, which is used to determine whether the current communication state is a first state period or a second state period. This status signal50 may be issued by one or more external devices 51 as sources, for example, it may be issued by a system control center, government department, or military command department outside the communication system.

The issuance of the status signal 50 may be based on various conditions, such as national security status, natural disaster alerts, major public events, network security threat levels, etc. The following lists explanations for distinguishing between the first state period and the second state period under different scenarios:

Natural Disaster States:
First state period: Normal weather conditions.
Second state period: Occurrence of natural disasters such as typhoons, earthquakes, floods, tsunamis.

Public Health Events:
First state period: Daily health conditions.
Second state period: Epidemic outbreaks, biological crises, etc.

### Network Security Levels:

First state period: Normal network security state.
Second state period: Occurrence of suffering large-scale network attacks or data breach threats.

### Environmental Pollution Events:

First state period: Normal environmental conditions.
Second state period: Occurrence of serious air pollution, water pollution, or nuclear leakage events.

### Social Security Situations:

First state period: Social stability period.
Second state period: Occurrence of large-scale social unrest or terrorist attack events.

Next, the communication system selects the appropriate communication mode based on the received status signal 50. When the status signal 50 indicates that the current state is the first state period, the system activates the first communication mode. In this mode, the plurality of communication devices 111,112, 113 interconnect and communicate through the first communication platform server 121 of the fixed base station 12.

However, when the status signal 50 indicates that the current state is the second state period, the system switches to the second communication mode. In this mode, the plurality of communication devices 111,112, 113 selectively interconnect and communicate through the second communication platform server131 of the mobile communication vehicle 13 or the third communication platform server 141 of the satellite 14. For example, if the plurality of communication devices 111, 112, 113 can connect to the second communication platform server 131 of the mobile communication vehicle 13, they interconnect and communicate in this manner, but if they cannot connect to the second communication platform server 131 of the mobile communication vehicle 13, they switch to interconnecting and communicating through the third communication platform server 141 of the satellite 14.

In addition, to ensure data synchronization between different communication platform servers 121, 131, 141, a synchronization frequency value can also be set in this system. The synchronization frequency value is used to control the data synchronization frequency between the first communication platform server 121, the second communication platform server 131, and the third communication platform server 141. In the disclosure, any of the first, second, and third communication platform servers 121, 131, 141 can set a synchronization frequency value and then synchronize data with other communication platform servers according to the synchronization frequency value.

The setting of the synchronization frequency value is not fixed but can be dynamically adjusted based on multiple reference parameters. These reference parameters include: network connection status between communication platform servers, amount of data changes on each communication platform server, current processing load of each communication platform server, and data volume of different data types. For example, when network connection status is good, the system may increase the synchronization frequency; when a server's processing load is high, the system may decrease the synchronization frequency with that server. For important or frequently changing data types (such as text data, voice data, image data, video data), the system may set higher synchronization priorities.

Finally, the system performs data synchronization between the first communication platform server 121, the second communication platform server 131, and the third communication platform server 141 according to the set synchronization frequency value. This ensures that regardless of which platform the communication devices 111, 112, 113 communicate through, all important data can be updated timely across all platforms.

Data synchronization methods may include various technologies. For example, incremental synchronization technology can be used to transmit only changed data to reduce network burden. Multi-version concurrency control (MVCC) technology can also be adopted to handle concurrent updates. For large data synchronization, batch synchronization technology may be used during periods of low network load. Under poor network conditions, compression technology or incremental encoding technology maybe employed to reduce the amount of transmitted data. Additionally, the system may also use distributed database technologies such as Apache Cassandra or Cockroach DB to achieve cross-platform data consistency.

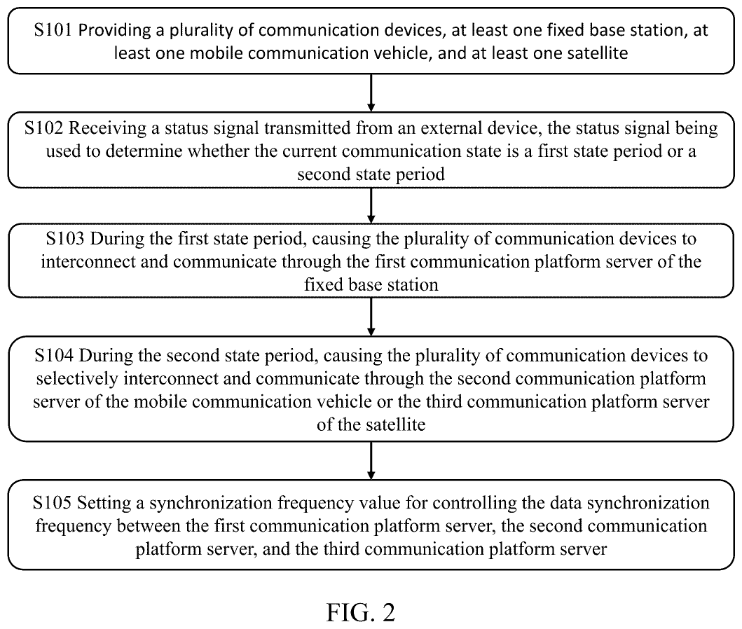

FIG. 2 shows a flowchart of a multi-state ground and space communication method according to a preferred embodiment of the disclosure. As shown in FIG. 2, it includes:
Step 101: Providing a plurality of communication devices 111, 112, 113, at least one fixed base station 12, at least one mobile communication vehicle 13, and at least one satellite 14, wherein the fixed base station 12 has a first communication platform server 121 built therein, the mobile communication vehicle 13 has a second communication platform server 131 built therein, and the satellite 14 has a third communication platform server 141 built therein.
Step 102: Receiving a status signal transmitted from an external device, the status signal being used to determine whether the current communication state is a first state period or a second state period. The external device may be issued by a system control center, government department, or military command department, but the disclosure is not limited thereto. The status signal is used to determine whether the current communication state is a first state period or a second state period. This state distinction may be based on various conditions, such as national security status, natural disaster alerts, major public events, network security threat levels, etc. In the disclosure, at least one of the first, second, or third communication platform servers 121, 131, 141 can receive and process this status signal, then inform other communication platform servers whether the current communication state is a first state period or a second state period.
Step 103: During the first state period, causing the plurality of communication devices 111, 112, 113 to interconnect and communicate through the first communication platform server 121 of the fixed base station 12. In this mode, the plurality of communication devices 111, 112, 113 interconnect through the first communication platform server 121 of the fixed base station 12. Communication activities such as data transmission, voice calls, and video conferences between the plurality of communication devices111, 112, 113 are all routed and processed through the first communication platform server 121 of the fixed base station 12.
Step 104: During the second state period, causing the plurality of communication devices 111, 112, 113 to selectively interconnect and communicate through the second communication platform server 131 of the mobile communication vehicle 13 or the third communication platform server 141 of the satellite 14. In one embodiment of the disclosure, the system first attempts to cause the plurality of communication devices 111, 112, 113 to interconnect and communicate through the second communication platform server 131 of the mobile communication vehicle 13. If this connection cannot be established or maintained, the system automatically switches to causing the plurality of communication devices 111, 112, 113 to communicate through the third communication platform server 141 of the satellite 14. This flexible switching mechanism ensures continuous operation of the communication system under various extreme conditions (such as natural disasters, public health events, etc.).

In some embodiments, the method may further includes the Step 105: Setting a synchronization frequency value for controlling the data synchronization frequency between the first communication platform server 121, the second communication platform server 131, and the third communication platform server 141.

To ensure data consistency between different communication platforms, the system of the disclosure can set a synchronization frequency value for controlling the data synchronization frequency between the first communication platform server 121, the second communication platform server 131, and the third communication platform server 141. The synchronization frequency value is not fixed but can be dynamically adjusted based on multiple reference parameters, including: network connection status between communication platform servers, amount of data changes on each communication platform server, current processing load of each communication platform server, and data volume of different datatypes.

In the disclosure, each communication platform server can be set with a synchronization frequency value or receive a synchronization frequency value transmitted from other communication platform servers, and execute data synchronization operations accordingly. Data synchronization may employ various technologies such as incremental synchronization, multi-version concurrency control (MVCC), batch synchronization, compression technology, etc., to ensure efficient synchronization under various network conditions.

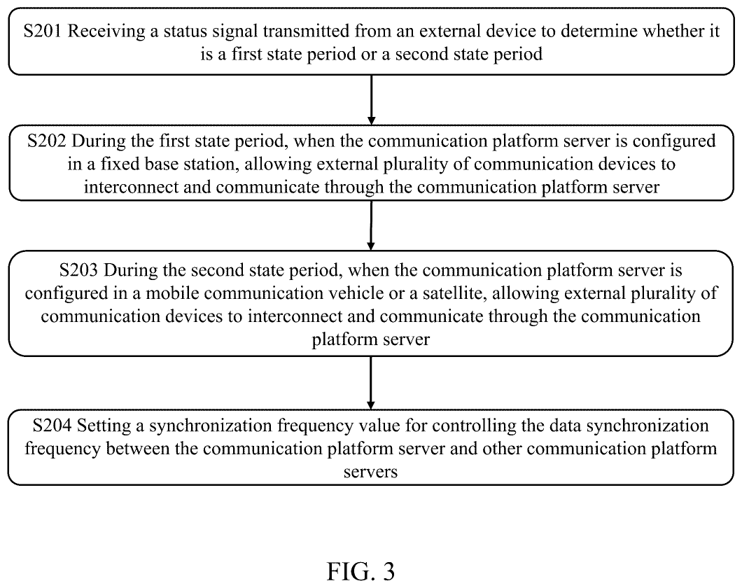

FIG. 3 shows a flowchart of a communication method of a communication platform server according to a preferred embodiment of the disclosure. As shown in FIG. 3, it includes:
Step 201: Receiving a status signal transmitted from an external device to determine whether it is a first state period or a second state period.
Step 202: During the first state period, when the communication platform server is configured in a fixed base station, allowing external plurality of communication devices to interconnect and communicate through the communication platform server.
Step 203: During the second state period, when the communication platform server is configured in a mobile communication vehicle or a satellite, allowing external plurality of communication devices to interconnect and communicate through the communication platform server.
Step 204: Setting a synchronization frequency value for controlling the data synchronization frequency between the communication platform server and other communication platform servers.

Through the multi-state ground and space communication system and communication method proposed by the disclosure, a multi-state communication method that can adapt to different situations is provided. It can not only provide efficient communication services under normal circumstances but also quickly switch to alternative communication methods in emergency situations, while ensuring information consistency and real-time performance through intelligent data synchronization mechanisms. This flexibility and reliability make the system particularly suitable for scenarios requiring stable communication maintenance in various complex environments, such as military communications, disaster relief, large event security, critical infrastructure protection, and other fields. The system design considers different usage scenarios and possible failure modes, ensuring communication continuity and reliability while also leaving room for future technology upgrades and expansion.

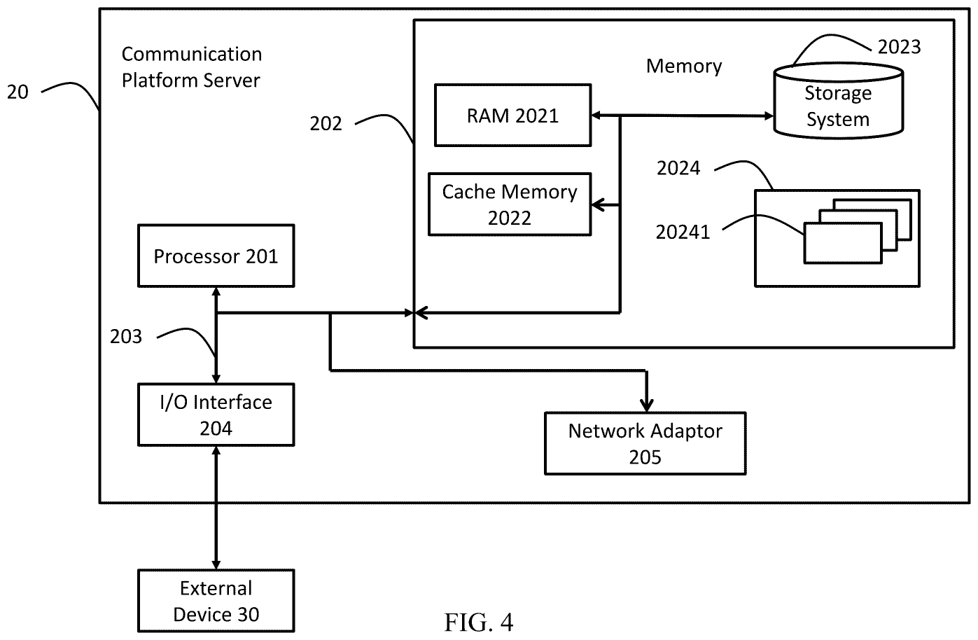

FIG. 4 shows a block diagram of a communication platform server 20 suitable for implementing embodiments of the disclosure. The communication platform server 20 shown in FIG. 4 is merely an example and should not impose any limitations on the functions and scope of use of the embodiments of the disclosure.

As shown in FIG. 4, the communication platform server 20 is represented in the form of a general-purpose computing device. Components of the communication platform server 20 may include, but are not limited to: one or more processors (processing units) 201, memory 202, and a bus 203 connecting different system components (including memory 202 and processor 201).

Bus 203 represents one or more of several types of bus structures, including memory buses or memory controllers, peripheral buses, graphics acceleration ports, processors, or local buses using any of various bus architectures. For example, these architectures include, but are not limited to, Industry Standard Architecture (ISA) buses, Micro Channel Architecture (MAC) buses, Enhanced ISA buses, Video Electronics Standards Association (VESA) local buses, and Peripheral Component Interconnect (PCI) buses.

The communication platform server 20 typically includes various computer system readable media. These media can be any available media accessible by the communication platform server 20, including volatile and non-volatile storage media, removable and non-removable storage media.

Memory 202 may include computer system readable media in the form of volatile memory, such as random access memory (RAM) 2021 and/or cache memory 2022. The communication platform server 20may further include other removable/non-removable, volatile/non-volatile computer system storage media. By way of example only, storage system 2023 can be used for reading and writing non-removable, non-volatile magnetic media (not shown in FIG. 4, commonly called “hard drives”). Although not shown in FIG. 4, magnetic disk drives for reading and writing removable non-volatile magnetic disks (e.g., “floppy disks”) and optical disk drives for reading and writing removable non-volatile optical disks (e.g., CD-ROM, DVD-ROM, or other optical media) can be provided. In these cases, each drive can be connected to bus203 through one or more data media interfaces. Memory 202 may include at least one program product having a set (e.g., at least one) of program modules configured to perform functions of various embodiments of the disclosure.

Program/utility 2024 having a set (at least one) of program modules 20241 may be stored in, for example, memory 202. Such program modules 20241 include, but are not limited to: operating systems, one or more application programs, other program modules, and program data. Each of these examples or some combination thereof may include implementations of network environments. Program modules 20241 generally perform functions and/or methods in the embodiments described in the disclosure.

The communication platform server 20 may also communicate with one or more external devices 30 (e.g., keyboards, pointing devices, displays, etc.), and may also communicate with one or more devices that enable users to interact with the communication platform server 20, and/or with any devices (e.g., network cards, modems, etc.) that enable the communication platform server 20 to communicate with one or more other computing devices. This communication may be performed through input/output (I/O) interface 204. Moreover, the communication platform server 20 may also communicate with one or more networks (e.g., local area networks (LANs), wide area networks (WANs), and/or public networks such as the Internet) through network interface card 205. As shown in FIG. 4, network interface card 205 communicates with other modules of the communication platform server 20 through bus 202. It should be understood that although not shown in the figure, other hardware and/or software modules may be used in conjunction with the communication platform server 20, including but not limited to: microcode, device drivers, redundant processing units, external disk drive arrays, RAID systems, tape drives, and data backup storage systems, etc.

Processor 201 executes various functional applications and data processing by running programs stored in memory 202, such as implementing the methods in the embodiments shown in FIG. 4.

The disclosure also discloses a computer-readable storage medium having a computer program stored thereon, which, when executed by a processor, implements the methods in the embodiments shown in FIG. 4.

Any combination of one or more computer-readable media may be employed. The computer-readable medium may be a computer-readable signal medium or a computer-readable storage medium. Computer-readable storage media may be, for example, but not limited to: electrical, magnetic, optical, electromagnetic, infrared, or semiconductor systems, apparatus, or devices, or any combination thereof. More specific examples (non-exhaustive list) of computer-readable storage media include: electrical connections having one or more wires, portable computer diskettes, hard disks, random access memory (RAM), read-only memory (ROM), erasable programmable read-only memory (EPROM or flash memory), optical fibers, portable compact disk read-only memory (CD-ROM), optical storage devices, magnetic storage devices, or any suitable combination thereof. In this document, computer-readable storage media may be any tangible medium that contains or stores programs that can be used by or in conjunction with instruction execution systems, apparatus, or devices.

Computer-readable signal media may include data signals propagated in baseband or as part of a carrier wave, carrying computer-readable program code therein. Such propagated data signals may take various forms, including but not limited to: electromagnetic signals, optical signals, or any suitable combination thereof. Computer-readable signal media may also be any computer-readable medium other than computer-readable storage media that can send, propagate, or transmit programs for use by or in conjunction with instruction execution systems, apparatus, or devices.

Program code contained on computer-readable media may be transmitted using any appropriate medium, including but not limited to: wireless, wireline, optical cable, RF, etc., or any suitable combination thereof.

Computer program code for performing operations of the disclosure may be written in one or more programming languages or combinations thereof, including object-oriented programming languages such as Java, Smalltalk, C++, and conventional procedural programming languages such as “C” language or similar programming languages. The program code may execute entirely on a user's computer, partly on a user's computer, as a standalone software package, partly on a user's computer and partly on a remote computer, or entirely on a remote computer or server. In scenarios involving remote computers, the remote computer may be connected to the user's computer through any type of network, including local area networks (LANs) or wide area networks (WANs), or may be connected to external computers (e.g., through the Internet using Internet service providers).

What is claimed is:

1. A multi-state ground and space communication system, comprising:
a plurality of communication devices;
at least one fixed base station having a first communication platform server built therein;
at least one mobile communication vehicle having a second communication platform server built therein;
at least one satellite having a third communication platform server built therein;
wherein the first, the second, or the third communication platform server receives a status signal transmitted from an external device to determine whether a current communication state is a first state period or a second state period;
during the first state period, the plurality of communication devices are configured to interconnect and communicate through the first communication platform server of the at least one fixed base station; and
during the second state period, the plurality of communication devices are configured to selectively interconnect and communicate through the second communication platform server of the mobile communication vehicle or the third communication platform server of the satellite.

2. The multi-state ground and space communication system of claim 1, comprising: the first, the second, and the third communication platform servers setting a synchronization frequency value, the synchronization frequency value being used to control a data synchronization frequency between the first communication platform server, the second communication platform server, and the third communication platform server.

3. The multi-state ground and space communication system of claim 2, wherein the setting the synchronization frequency value is adjusted based on reference parameters, the reference parameters including: network connection status between the first, the second, and the third communication platform servers, amount of data changes on each of the first, the second, and the third communication platform server, current processing load of each of the first, the second, and the third communication platform server, or data volume of different data types.

4. A multi-state ground and space communication method, comprising the steps of:
providing a plurality of communication devices, at least one fixed base station, at least one mobile communication vehicle, and at least one satellite, wherein the at least one fixed base station has a first communication platform server built therein, the at least one mobile communication vehicle has a second communication platform server built therein, and the at least one satellite has a third communication platform server built therein;
receiving a status signal transmitted from an external device, the status signal being used to determine whether a current communication state is a first state period or a second state period;
during the first state period, causing the plurality of communication devices to interconnect and communicate through the first communication platform server of the fixed base station; and
during the second state period, causing the plurality of communication devices to selectively interconnect and communicate through the second communication platform server of the mobile communication vehicle or the third communication platform server of the satellite.

5. The multi-state ground and space communication method of claim 4, comprising: setting asynchronization frequency value for controlling a data synchronization frequency between the first communication platform server, the second communication platform server, and the third communication platform server.

6. The multi-state ground and space communication method of claim 5, wherein the setting of the synchronization frequency value is adjusted based on reference parameters, the reference parameters include: network connection status between communication platform servers, amount of data changes on each communication platform server, current processing load of each communication platform server, or data volume of different data types.

7. A communication platform server, comprising:
a processor;
a memory electrically connected to the processor;
a communication unit for data exchange with external plurality of communication devices and with other communication platform servers;
wherein the processor, based on instructions stored in the memory, is configured to:
receive a status signal transmitted from an external device to determine whether it is a first state period or a second state period;
during the first state period, when the communication platform server is configured in a fixed base station, allow external plurality of communication devices to interconnect and communicate through the communication platform server;
during the second state period, when the communication platform server is configured in a mobile communication vehicle or a satellite, allow external plurality of communication devices to interconnect and communicate through the communication platform server; and
set a synchronization frequency value for controlling a data synchronization frequency between the communication platform server and other communication platform servers.
